(19) United States
(12) Patent Application Publication
(10) Pub. No.: US 2022/0121294 A1
(43) Pub. Date: Apr. 21, 2022

(54) SYSTEMS AND METHODS FOR PROVIDING A MODULAR INTERACTIVE PLATFORM WITH SATELLITE ACCESSORIES

(71) Applicant: QNIVERSE, LTD., Kibutz Glil-Yam (IL)

(72) Inventors: JONATHAN SHEM-UR, TEL-AVIV (IL); AMIR BEN SHALOM, MODIIN (IL); OFER ATIR, HERZLIYA (IL)

(21) Appl. No.: 17/563,126

(22) Filed: Dec. 28, 2021

Related U.S. Application Data
(63) Continuation-in-part of application No. 17/462,027, filed on Aug. 31, 2021.
Application No. 17/462,027 is a continuation of application No. 16/497,803, filed on Sep. 26, 2019, now Pat. No. 11,137,835.
(60) Provisional application No. 63/130,863, filed on Dec. 28, 2020.
(60) Provisional application No. 62/669,402, filed on May 10, 2018.
(60) Provisional application No. 62/668,976, filed on May 9, 2018.
(60) Provisional application No. 62/619,837, filed on Jan. 21, 2018.
(60) Provisional application No. 62/598,233, filed on Dec. 13, 2017.

(51) Int. Cl. G06F 3/03; A63F 13/214; G06F 3/147

(52) U.S. Cl. CPC G06F 3/0308; G06F 3/147; G06F 3/0325; A63F 13/214

(57) ABSTRACT

An interactive visual display platform including low power wearable satellite accessories for identifying and interfacing with users. A visual display sensing surface generates graphical images according to objects detected proximate to the surface. Three dimensional gaming upon a two dimensional surface by the creation of environments according to a user's physical movements.

### CROSS-REFERENCE TO RELATED APPLICATIONS

This application claims the benefit of priority from U.S. Provisional Patent Application No. 63/130,863, filed Dec. 28, 2020, and is a continuation-in-part of U.S. patent application Ser. No. 17/462,027, which is a continuation of U.S. patent application Ser. No. 16/497,803 filed Sep. 26, 2019, which is a U.S. National Phase Application under 35 U.S.C. 371 of International Application No. PCT/IB2018/059990, which has an international filing date of Dec. 13, 2018, and which claims priority and benefit from all of U.S. Provisional Patent Application No. 62/598,233, filed Dec. 13, 2017, U.S. Provisional Patent Application No. 62/619,837, filed Jan. 21, 2018, U.S. Provisional Patent Application No. 62/668,976, filed May 9, 2018, U.S. Provisional Patent Application No. 62/669,402, filed May 10, 2018, and U.S. Provisional Patent Application No. 62/669,404, filed May 10, 2018, the contents and disclosures of all of which are incorporated herein by reference in their entirety.

### FIELD AND BACKGROUND OF THE DISCLOSURE

The disclosure herein relates to systems and methods for the provision and application of interactive visual display surfaces.

The applicant's copending U.S. patent application Ser. No. 17/462,027 describes modular interactive visual display surfaces which may be networked to each other and to a computer. Such interactive visual display surfaces may be able to detect objects in their vicinity and to interact with them. However the systems described therein may not be able to identify the different objects detected.

The need remains therefore for systems and methods for identifying objects detected by interactive visual display surfaces.

### SUMMARY OF THE INVENTION

It is a first aspect of the current invention to introduce a modular interactive visual display platform comprising at least one visual display sensing surface module, and at least one satellite accessory module.

The visual display sensing surface module typically comprises a display mechanism, a sensing mechanism and a communication unit. The display mechanism may be operable to generate and to display graphical images. The sensing mechanism may be operable to sense at least one parameter associated with at least one object proximate to the surface and the communication unit operable to communicate with at least one satellite accessory module. For example, the sensing mechanism may include a contactless monitor.

The satellite accessory module typically comprises an identification tag, and an accessory communication unit. The identification tag may be operable to uniquely identify the satellite accessory, and the accessory communication unit may be operable to communicate with the visual display sensing surface module. Optionally, the satellite accessory comprises an input mechanism, such as one or more buttons operable to select between at least a PRESSED state and an UNPRESSED state. Additionally or alternatively, the input mechanism comprises at least one orientation sensor operable to record orientation of the satellite accessory module.

Typically, the identification tag comprises a Radio-Frequency Identification (RFID) tag, which may be include a passive transceiver antenna. Optionally, the RFID tag may be operable to identify different orientations with different identification tags.

The satellite accessory module may comprise a wearable unit configured to be worn by a user and operable to uniquely identify the user. For example, the wearable unit may comprise items such as rings, bracelets, chains, tokens, vests, pants, shirts, buckles, belts, shoes and the like as well as combinations thereof.

The satellite accessory module may further comprise an output interface operable to communicate with a user. By way of example, the output interface may include visual indicators, light emitting diodes, electroluminescence, E-INK, LCD. vibration generators, piezoelectric vibrators, electromechanical actuator, audio outputs and the like as well as combinations thereof. Where appropriate, the satellite accessory further comprises a power pack which may be used to power the output units.

The visual display sensing surface module comprises at least one proximity sensor operable to sense physical movement in a proximal zone around the sensing surface. The proximity sensor may be operable to detect at least one parameter of an object within the proximal zone, the at least one parameter selected from the group consisting of location, distance, height, intensity, weight, velocity, acceleration and combinations thereof.

The visual display platform may further include a computing mechanism configured and operable to arrange and display graphical images displayed upon the display mechanism surface according to a user's movements within a proximal zone around the sensing surface.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 is a block diagram schematically representing elements of a modular interactive platform with satellite accessories according to the current disclosure;

FIG. 2A is schematic representation of an interactive visual display surface of the current disclosure;

FIG. 2B is a schematic representation illustrating a networked pair of interactive of a visual display surface of the current disclosure;

FIGS. 3A and 3B show illustrations of an embodiment of proximity sensing hardware devices;

FIGS. 4A-C illustrate possible embodiments of the satellite module for use with the modular interactive platform;

FIG. 5 illustrates how a visual image displayed upon the interactive platform may respond to the motion of a user upon the surface.

### DETAILED DESCRIPTION

The disclosure herein relates to systems and methods for providing three dimensional gaming upon a two dimensional interactive playground surface . In particular, the methods described herein allow the creation of environments built of coordinated combination of user's physical movements regarding images' changes in distance and positions accordingly on an interactive surface on the ground.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

### Description of the Embodiments

In one embodiment of the current invention, a platform is provided for allowing a user to move physically on a playground surface upon which a lifelike feeling is created of a three dimensional environment. The illusion of a region extending down below the surface may be created by varying the size and scope of the image displayed thereupon.

Images may grow or shrink according to the users movements, say hopping and jumping on a virtual landscape displayed upon a platform underfoot. For example, the higher a user jumps the smaller the landscape may become, and vice versa. Accordingly, the more the objects get bigger the deeper the illusion a user experiences of a fall.

Interactive surfaces may include a display constructed from bulbs, LEDS, or any other visual display means which are controlled by a computing device of any kind. Users may perform various movements and actions upon such display surfaces.

In order to sense physical movements and gestures upon the surface, a matrix of touch and proximity sensors may be provided. Such sensors may be selected so as to detect location, distance, height, intensity, weight, pressure and velocity of objects within the vicinity of the interactive surface in real time.

A computing means that detects and processing the user's activity in real time may also be provided to further calculate the sensors indication of the user's position in the air during his hops and presents the environments accordingly. Such a computing controller may be operable to run, monitor and record events of all activities upon, above or around the interactive surface, including games, pictures, and gestures.

Accordingly, the computing mechanism may be configured and operable to arrange and display figures and landscape displayed upon the surface according to user's movements upon the playground and the changing points of view of the user created by those movements or physical objects movements up to any displayed activity.

An interactive system is provided comprising: at least one interactive visual display surface; at least one interactive computer being interconnected to said surface comprising an operating system; wherein said at least one surface is configured to sense at least one parameter of at least one object on said surface; send to said at least one interactive computer, at least one digital input data based on said at least one parameter; receive at least one digital output data from said at least one interactive computer; and wherein said at least one digital output data comprises at least one graphical information; and display said at least one graphical information on said at least one interactive surface; wherein said at least one parameter is selected from impact of said object on said surface, location of object on said surface, velocity of object on said surface, heat of object on said surface, height of object from said surface and any combination thereof.

The term “interactive system” should be understood to encompass a system being in coordinated interaction with at least one user operating it, at least one interactive visual display surface and at least one interactive computer and any communications.

The term “interactive visual display surface” should be understood to encompass any surface that is capable of displaying an interface that is received from the at least one interactive computer and is capable of sensing at least one parameter of an object placed on said surface, comprising impact of said object on said surface, velocity of object on said surface, heat of object on said surface, location of object on said surface, height of object from said surface and any combination thereof. The surface can send to said at least one interactive computer, at least one digital input data based on said at least one parameter; receive at least one digital output data from said at least one interactive computer; and wherein said at least one digital output data comprises at least one graphical information; and display said at least one graphical information on said at least one interactive surface.

In some embodiments, said interactive visual display surface is connected directly to the internet (using any type of communication technology such as for example Wi-Fi technology, Bluetooth technology and so forth).

In some further embodiments said interactive visual display surface is an assembly of two and more (at least two) visual display surfaces interconnected between them to provide a uniform display surface, connectively displaying said graphical information. Under these embodiments, said at least two interactive visual display surfaces provide together the entire graphical information.

The term “object” should be understood to encompass any three-dimensional object that is placed on said surface and can create at least one parameter sensed by said surface. Said object may be a still object moved by the user on the surface of said system. In other embodiments said object is the body of the user himself that is moving on the surface of said system.

Said at least one interactive surface comprises at least one sensor configured to sense said at least one parameter of at least one object on said surface. In some embodiments said at least one sensor is an electrooptic sensor (in some embodiments said sensor can detect the difference in light shade and/or light intensity on said interactive surface and thus detect a parameter of said object on said surface, such as for example the location of said object, the velocity of said object and so forth). In some further embodiments said sensor is embedded and/or integrated within said interactive surface.

Said at least one interactive surface sends to said at least one interactive computer, at least one digital input data based on said at least one parameter, after which it receives at least one digital output data including at least one graphical information, from said at least one interactive computer. The interactive surface then displays said at least one graphical information.

Said user interaction includes, but is not limited to any type of parameter of the user on said at least one interactive visual display surface as for example impact, location of object on said surface, velocity, heat, height and so forth and any combination thereof. Said at least one interactive visual display surface is configured to sense at least one parameter on said surface thereby sending to said at least one interactive computer at least one digital input data based on said at least one parameter.

Said at least one interactive visual display surface receives at least one digital output data from said at least one interactive computer which comprises at least one graphical information being displayed as an at least one graphical information on said at least one interactive surface.

In some embodiments, said interactive computer can further receive input from at least two interactive visual display surfaces.

In further embodiments, said at least one output data further comprises at least one audio signal information.

In other embodiments, said at least one interactive surface comprises a capacitive multi-touch LED display surface or any other type of display technology.

In further embodiments, said at least one interactive computer is also connected to the web network. In some other embodiments, at least one interactive computer is selected from a hand-held computer, a portable computer, a stationary computer, a cell phone, a tablet computer, a game console or any combinations thereof.

In other embodiments, said at least one interactive surface and/or at least one interactive computer comprises at least one transponder. Said transponder is capable of transmitting information between at least one interactive surface and at least one interactive computer.

In other embodiments, said operating system on said at least one interactive computer is programmed to provide an interactive CGI display on said at least one interactive visual display. In other embodiments, said program providing an interactive CGI display on said at least one interactive visual display is a computer game program.

In other embodiments, said program providing an interactive CGI display on said at least one interactive visual display is a computer interactive program.

In further embodiments, said at least one interactive visual display surface is placed on the ground, the table, or on the wall.

In other embodiments, said system comprises at least two interactive visual display surfaces. In further embodiments, said at least two interactive visual display surfaces are perpendicular to each other.

In some other embodiments, said at least one interactive visual display surface has the size of at least about 0.40 m×0.40 m.

In further embodiments, said at least one interactive visual display surface has the size of at least about 1 m×2 m.

In further embodiments, said at least one interactive visual display surface module can be connected to one or more interactive visual display surface to establish a bigger surface.

In another aspect, the invention provides a method of operating an interactive program with at least one user; said method comprises: providing an interactive system comprising at least one interactive visual display surface; at least one interactive computer being interconnected to said surface comprising an operating system; wherein said at least one surface is configured to sense at least one parameter; send to said at least one interactive computer, at least one digital input data based on said at least one parameter; receive at least one digital output data from said at least one interactive computer; wherein said at least one digital output data comprises at least one graphical information; and display said at least one graphical information through said at least one interactive surface; displaying on said interactive surface an interactive graphical display created by said operating system of said at least one interactive computer; sensing at least one parameter of at least one user by said at least one interactive surface and any parameters thereof; generating at least one digital input data based on said at least one parameter and parameters thereof; sending at least one digital input data to said at least one interactive computer; generating at least one digital output data by said operating system on said at least one interactive computer; sending said at least one digital output data from said interactive computer to said at least one interactive surface; displaying graphically using said interactive graphical display on said interactive surface said at least one digital output data on said interactive surface.

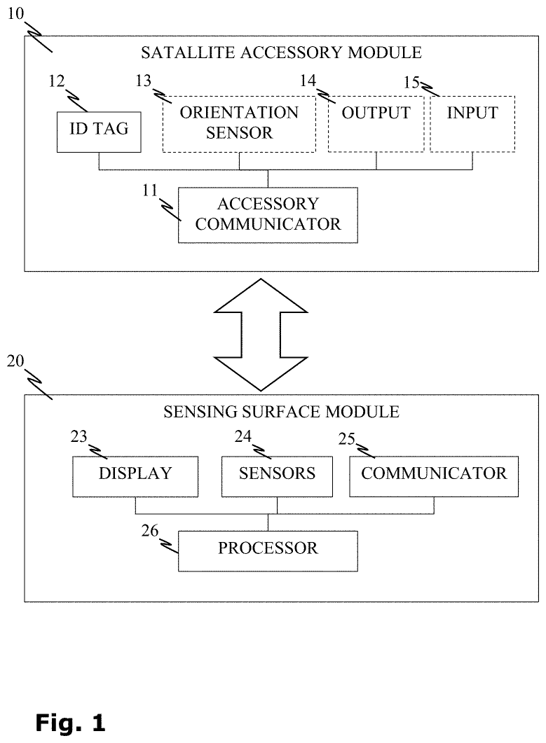

Reference is now made to the block diagram of FIG. 1 which schematically represents selected elements of a modular interactive platform with satellite accessory according to the current disclosure.

The modular interactive platform comprises at least one visual display sensing surface module 20, and at least one satellite accessory module 10.

The visual display sensing surface module 20 includes a display mechanism 23, a sensing mechanism 24 and a communication unit 25. The display mechanism 23 may use light emitting diodes or other visual output units so as to generate and display graphical images.

The sensing mechanism 24 is provided to sense at least one parameter associated with objects proximate to said surface module 20.

The communication unit 25 is provided to communicate with the satellite accessory module 10 as required.

The satellite accessory module 10 includes an identification tag 12, and an accessory communication unit 11. Where required, the satellite accessory module 10 may further include an output mechanism 14 and an input mechanism 15 which may provide an interface for a user.

The identification tag 12 is a unique identifier of the satellite accessory 10. Accordingly, the accessory communication unit 11 is operable to communicate the unique identity of the satellite to the visual display sensing surface module.

By way of example, the communication unit 11 may be a Radio-Frequency Identification (RFID) tag. Such as unit comprising an integrated circuit (IC), an inlay and an antenna. The RFID tag inlay may encode the identifying information.

Where appropriate, a passive RFID unit may be provided which has no power source of its own but instead harvests power from the electromagnetic wave of the interrogating signal transmitted by the communication unit 25 of the surface module 20 which may induce a current in the RFID tag's coil antenna.

The input mechanism 15 may provide a user interface via which the user may communicate information to the surface module 20. For example, the input mechanism 15 may include one or more buttons which are operable to select between at least a PRESSED state and an UNPRESSED state.

It is a feature of embodiments of the satellite accessory module 10 that it may be a low power device including a passive RFID circuit. Accordingly, the interface buttons may be configured to select different RFID tag inlays in the PRESSED state and the UNPRESSED state. Such a mechanism may be a hardware switch connecting the coil antenna to different inlays as required. It will be appreciated that multiple switches may be configured to select any number of inlays and therefore communicate more complex signals to the surface unit.

In further embodiments, the input mechanism 15 may inlcude at least one orientation sensor which may be able to detect Pitch, Roll and Yaw of the satellite accessory and to select different identification tags accordingly.

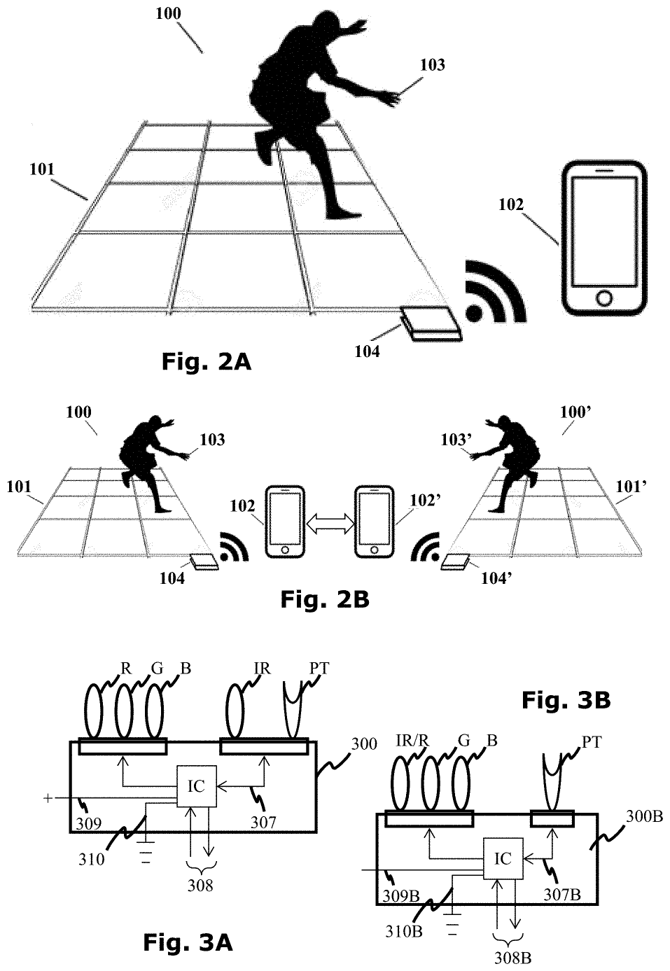

FIG. 2A is a schematic embodiment of an interactive system such as described in the applicant's copending U.S. patent application Ser. No. 17/462,027, which is incorporated herein by reference. The system of FIG. 2A 100 comprises an interactive visual display surface 101; an interactive mobile computer 102 both being interconnected to each other using an operating system and at least one transponder 104. The surface 101 is configured to sense at least one parameter on said surface by a user 103 stepping or touching it, then sending to said interactive computer at least one digital input data based on said at least one parameter. The computer 102 generates at least one digital output data which is received by said surface which is translated to at least one graphical information displayed on said interactive surface.

FIG. 2B depicts another embodiment of a system of the invention, which comprises two interactive visual display surfaces 100 and 100′; two interactive mobile computers 102 and 102′ each being interconnected to the each other using an operating system and at least one transponder 104 and 104′ for each. The surfaces 100 and 100′ are configured to sense at least one parameter on said corresponding surface by two individual users 103 and 103′ stepping or touching each corresponding, then each sending to said interactive computer at least one digital input data based on said at least one parameter of both users. The computers 102 and 102′ generate at least one digital output data which is received by both surfaces which is translated to at least one graphical information displayed on both interactive surfaces.

In other embodiments, the interactive platform may be a modular system including at least one master tile which may optionally be combined with one or more interactive accessory modules in order to provide additional functionality as required.

Accordingly the interactive platform may provide varying functionality depending upon the number and combination of modules used.

According to certain embodiments, the master tile module may provide a platform, say a square about 80 centimeters by 80 centimeters or thereabouts which may support a number of features including: a celling light reflection feature, programmable music and sounds effects, an internal alarm clock, an auto-shutdown allowing the platform to turn itself off under predetermined conditions such as after a certain amount of time. The master tile may allow the concurrent sensing of pressures and proximity allowing the user to interact with the platform via touch, for example by hands or feet. The master tile may further allow users to select required indications to setup sleep-time ambiance and wake-up modes.

Furthermore the master tile may include operational components, such as speakers, central processing unit (CPU), and power units. The master tile may also include a communication unit allowing the master to that the master may interact with satellite accessories via a communication protocol such as Bluetooth, Low energy Bluetooth, WiFi, Zigbee or any other required communication protocol as required.

Where appropriate, the visual display sensing surface module may include at least one proximity sensor operable to sense physical movement in a proximal zone around the sensing surface. Proximity sensors may be operable to detect at least one parameter of an object within a proximal zone such around the perimeter or above the platform, Monitored parameters may be, for example, the location of the detected object, the radial distance to the object, the height above the platform, signal intensity, weight, velocity, acceleration of the object and the like as well as combinations thereof.

In various examples of the interactive platform a surface may be provided with proximity sensing devices operable to detect an object nearby. For example, proximity sensing hardware devices may comprise at least one RGB LED illuminator; at least one independent IR led with photo-resistor or wide range IR led emitting in the IR range; at least one IC (Integrated Circuit) managing the RGB illumination, controlling the operation of the IR and range sensor; The described device may be incorporated into electronic circuits and may include a communication bus providing a bi-directional protocol and/or allowing daisy chaining of multiple devices. The method of operation consists of individually addressing a device instance for setting a specific RGB combination which will result in the device visually displaying the set color or reading a distance measurement from the device being addressed.

The device may include red, green and blue LEDs combined with an independent IR (Infra-red spectrum) LED, a phototransistor that is able to measure IR radiation and their controlling IC. Alternatively or additionally, the proximity sensing device may include a green LED, a blue LED and a red LED having a wide range emission spectrum such that it emits in both of the IR and visible ranges, as well as the IR sensitive phototransistor and their controlling IC. It is noted that the wide range spectrum red LED enables the control of the red spectrum emitting frequencies, between the visible red ranges and the IR spectrum ranges as required.

The device may further include an IC managing the RGB illumination, controlling the operation of the range sensor, providing addressing and communication, and if a wide spectrum red LED is used timing (frequency) to switch between the visible spectrum RGB illumination and IR spectrum distance detection.

FIG. 3A is a schematic embodiment of a proximity sensing hardware device 300. The hardware device 300 comprises a blue LED B a green LED G; a red LED R. The RGB LEDs color and intensity are controlled by the embedded integrated circuit (IC). The hardware device 300 comprises also a Infra-Red spectrum LED IR; an IR sensitive phototransistor PT operable to measure IR radiation; The IR LED radiation and span is controlled via line connection 307 by the embedded integrated circuit (IC). The IR sensitive phototransistor PT measurements of the IR radiation via line connection 307 is readable by the integrated circuit IC. The integrated circuit IC is connected via lines 308 that provides bi-directional communication that allows also daisy chaining of multiple devices. The integrated circuit IC allows individually to address a specific device instance for setting specific RGB combination, and/or reading distance measurement from the specific instance device being addressed 305. Common power supply line 309; Common ground line 310.

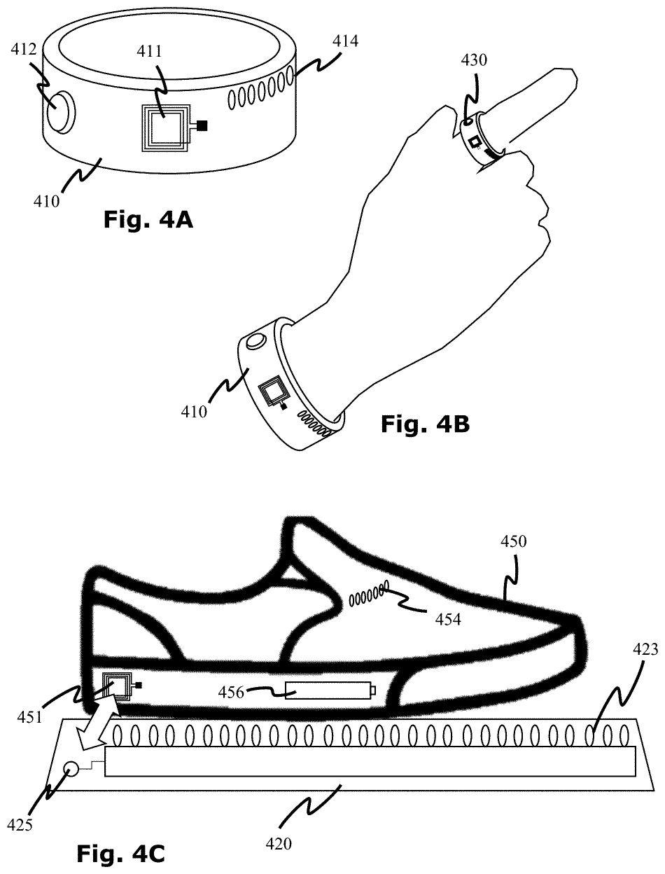

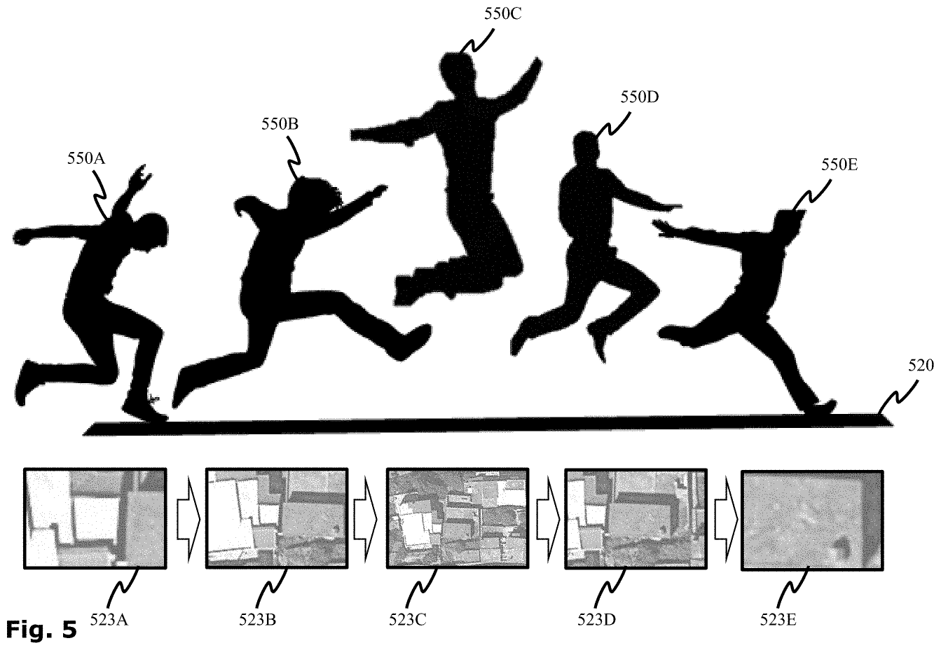

FIG. 3B depicts another embodiment of the proximity detecting hardware device in its optimized configuration of the invention. The hardware device of FIG. 4 300B comprises a blue LED B; a green LED G; a wide range red spectrum LED IR/R capable of emitting both in the IR spectrum and the visible red spectrum. The RGB LEDs color and intensity are controlled by the embedded integrated circuit (IC). The wide range spectrum red LED IR/R is controlled by the integrated circuit IC also for switching between the visible red spectrum and the IR red spectrum at a controlled frequency. The hardware device 300B comprises also an IR sensitive phototransistor that able to measure IR radiation PT; The wide range spectrum LED IR/R radiation, intensity, duration and frequency is controlled by the embedded integrated circuit (IC). The IR sensitive phototransistor PT measurements of the IR radiation are communicated via a line connection 307B and are readable by the integrated circuit IC; The integrated circuit IC is connected via lines 308B that provides bi-directional communication that allows also daisy chaining of multiple proximity detecting devices. The integrated circuit IC allows individually to address a specific device instance for setting specific RGB combination, and IR radiation, and/or reading distance measurement from the specific instance device being addressed. Common power supply line 309B; Common ground line 310B.

With reference now to FIG. 4A, a possible embodiment of a satellite accessory module 410 is presented for illustrative purposes. The satellite accessory module 410 is an electronically enabled band for use with a modular interactive platform.

The satellite accessory may include an RFID tag 411, and a user interface including a push button 412 and a visual output display 414. It is noted that other output interfaces may provide user feedback via other indicators such as visual indicators, such as liquid crystals, light emitting diodes, electroluminescence elements, E-INK, and the like; tactile outputs such as vibration generators, piezoelectric vibrators, electromechanical actuators, and the like and audio outputs such as speakers, buzzers, bells and the like.

It will be appreciated that where output generation is required, a power pack such as a battery may be provided in the accessory to power the output as required. Alternatively, a passive unit having no onboard power source may transmit to the board using a passice RFID tag.

The satellite accessory module is provided as a wearable unit configured to be worn by a user and operable to uniquely identify the user. For example, such a band may be worn as a ring 430 or a bracelet 410 as indicated in FIG. 4B.

In one particular system a flexible ring accessory may include multicolor led bulbs and communication means to connect with the surface. The ring 430, the bracelet 410 either individually or in combination may be configured and operable to detect location, movements and gestures of the wearer such as the pointing finger indicated in FIG. 4B.

In particular examples, commands may be selected by orientating the ring on the finger and/or by pressing designated buttons on it. The ring may further indicate moves within the game, victories, failures and achievements by means of color changes, emitted sounds, vibrations or the like.

Such satellite units may feature very low power consumption. Further, the satellite units may have multiple orientations which may be identified by the RFID receptor as a with different identity, This allows to use of the technology as a multi position switch for multiple operations.

Other wearable units include items such as chains, necklaces, tokens, vests, pants, shirts, buckles, belts, shoes and the like as well as combinations thereof. With reference now to FIG. 4C, still another satellite accessory 450 may be provided by incorporating an RFID tag 451, a power supply 456 and an output display 454 into a plimsole, a shoe or the like.

Accordingly the satellite may be able to communicate with the base platform 420 via its communication unit 425 and the visual display 423 of the base platform may be adjusted as appropriate. The wearable accessory may be further configured and operable activate sensors on the surface.

Optionally the RFID antenna of the communication unit 425 maybe distributed around the edge of the base platform. In some embodiments, the RFID may have a range of around one meter about the perimeter such that, when a user is close to the playground, the RFID tag is detected and the user identified. The RFID identity may be saved in the user's profile and be used to identify a unique player. Alternatively, when a new user is detected with an unknown ID, the system may prompt the user to register a new player profile.

Accordingly, various techniques and hardware may be provided for sensing and monitoring movements and gestures nearby the interactive surface. In particular, systems and methods may sense movement without creating any physical contact between the user and the surface. Such contactless monitoring may result is an expansion of the actual interactive space into an extended zone region beyond the physical limits of the platform surface itself.

The logical size of a digital playground may be extended to increase the play value of the playground. Features extending value may include: a memory storing executable code directed towards being aware that a player that is nearby the borders of the playground; a sensing zone extending of a range between say 20-50 cm; sensing may be based on proximity and/or directional sensors; player proximity and movement direction may be reported back to a central processing unit; game and activity may respond to player movements on the edge of the playground; the playground may automatically activate when a user passes nearby; the SDK may provide means to add the peripheral sensing to the game and peripheral sensors may be deactivated when necessary, possibly by software.

Where required, proximity sensors may be integrated into the surface. Such proximity sensors may detect any movements or gestures, including location, height, intense, velocity and weight.

Referring back to FIG. 1, it is further noted that the sensing surface module 20 may include a processor 26 for analyzing the data provided by the sensors 24 as well as the communicator 25. The processor 26 may be operable to arrange and display graphical images displayed upon the display 23 of the base unit according to a user's movements within a proximal zone around the sensing surface.

With reference to FIG. 5 an example is presented illustrating how a visual image 523A-E displayed upon the interactive platform 520 may respond to the motion of a user 550A-E.

Such a system may be used for example in gaming applications such as a downhill parkour game in which an image is presented of a little old town on a hill. The roofs of the buildings are almost touching each other down the slope. The presentation creates the illusion that the user is standing on a roof on top of the hill. The game may proceed with the user moving downhill by hopping from roof to roof in a parkour style.

Thus, when jumping in the air, at first the targeted roof may shrink so as to simulate moving away but as the player reaches the highest point in the jump the targeted roof may grow to simulate getting closer and closer, while all other objects in the landscape are changing their previous positions according to the changing position of the jumper.

Peripheral proximity sensor may be used to enable synchronization of growth and shrink with user position in such applications. Additionally or alternatively, other methods such as timing according to a kinematic function may be applied.

FIG. 5 illustrates a user 550 leaping from a first roof to a second roof by leaping over the gap between them.

Initially, the user 550A stands upon a close up image 523A which represents the roof upon which he stands. As the user leaps 550B sensors may detect the motion and the displayed image 523B zooms out to include more surrounding features such that the illusion is created that the user is rising high into the air, this continues until the user 550C reaches the apex of the jump at which point the image 523C is at its furthest, where the houses of the town seem smaller the more they are far away. As the sensors detect that the user 550D begins to descend, the image 523D zooms back in upon the adjacent roof, and such that illusion is created that the user 550E has jumped a far greater distance to land upon a close up of the adjacent roof.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like intended to include all such new technologies a priori.

As used herein the term “about” refers to at least ±10%. The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of.”

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6, should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range .

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims. Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting. The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. A modular interactive visual display platform comprising at least one visual display sensing surface module, and at least one satellite accessory module, wherein:
said at least one visual display sensing surface module comprises a display mechanism, a sensing mechanism and a communication unit, said display mechanism operable to generate and to display graphical images, said sensing mechanism operable to sense at least one parameter associated with at least one object proximate to said surface and said communication unit operable to communicate with said at least one satellite accessory module; and
said at least one satellite accessory module comprises an identification tag, and an accessory communication unit, said identification tag operable to uniquely identify the satellite accessory, and the accessory communication unit is operable to communicate with the visual display sensing surface module.

2. The modular interactive visual display platform of claim 1 wherein the at least one satellite accessory comprises an input mechanism.

3. The modular interactive visual display platform of claim 2 wherein the input mechanism comprises at least one button operable to select between at least a PRESSED state and an UNDRESSED state.

4. The modular interactive visual display platform of claim 2 wherein the input mechanism comprises at least one orientation sensor operable to record orientation of the satellite accessory module.

5. The modular interactive visual display platform of claim 1 wherein the identification tag comprises a Radio-Frequency Identification (RFID) tag.

6. The modular interactive visual display platform of claim 5 wherein the RFID tag is operable to identify different orientation with different identification tags.

7. The modular interactive visual display platform of claim 5 wherein the RFID tag comprises a passive transceiver antenna.

8. The modular interactive visual display platform of claim 1 wherein the at least one satellite accessory module comprises a wearable unit configured to be worn by a user and operable to uniquely identify the user.

9. The modular interactive visual display platform of claim 8 wherein the wearable unit comprises an item selected from a group consisting of rings, bracelets, chains, tokens, vests, pants, shirts, buckles, belts, shoes and combinations thereof.

10. The modular interactive visual display platform of claim 1 wherein the at least one satellite accessory module further comprises an output interface operable to communicate with a user.

11. The modular interactive visual display platform of claim 10 wherein the output interface is selected from at least one of a group of outputs consisting of: visual indicators, light emitting diodes, electroluminescence, E-INK, LCD. vibration generators, piezoelectric vibrators, electromechanical actuator, audio outputs and combinations thereof.

12. The modular interactive visual display platform of claim 11 wherein the at least one satellite accessory further comprises a power pack.

13. The modular interactive visual display platform of claim 1 wherein the at least one visual display sensing surface module comprises at least one proximity sensor operable to sense physical movement in a proximal zone around the sensing surface.

14. The modular interactive visual display platform of claim 13 wherein the at least one proximity sensor is operable to detect at least one parameter of an object within the proximal zone, said at least one parameter selected from the group consisting of location, distance, height, intensity, weight, velocity, acceleration, pressure, movement based camera and combinations thereof.

15. The modular interactive visual display platform of claim 1 further comprising a computing mechanism configured and operable to arrange and display graphical images displayed upon the display mechanism surface according to a user's movements within a proximal zone around the sensing surface.

16. The modular interactive visual display platform of claim 1 wherein at least one sensing mechanism comprises a contactless monitor.

17. A satellite accessory module for a modular interactive visual display platform, the visual display platform comprising at least one visual display sensing surface module, said at least one satellite accessory module comprises:
a wearable unit configured to be worn by a user;
at least one identification tag operable to uniquely identify the user;
at least one accessory communication unit operable to communicate with the visual display sensing surface module, and
an output interface operable to communicate with the user.

18. The satellite accessory module of claim 17 further comprising at least one button operable to select between at least a PRESSED state and an UNPRESSED state.

19. The satellite accessory module of claim 17 further comprising at least one orientation sensor operable to record orientation of the satellite accessory module.

20. The satellite accessory module of claim 17 wherein the identification tag comprises a Radio-Frequency Identification (RFID) tag.
